(19) United States
(12) Patent Application Publication
(10) Pub. No.: US 2014/0207088 A1
(43) Pub. Date: Jul. 24, 2014

(54) MOXIBUSTION THERAPY DEVICE AND METHOD OF USING THEREOF

(71) Applicant: LIFERISING CORPORATION, Chicago, IL (US)

(72) Inventors: Zhengang GUO, Westmont, IL (US); Wenbin YAO, Beijing (CN); Weiguo CHEN, Beijing (CN); Peng PENG, Beijing (CN); Jingyang JIANG, Beijing (CN)

(73) Assignee: LIFERISING CORPORATION, Chicago, IL (US)

(21) Appl. No.: 14/156,835

(22) Filed: Jan. 16, 2014

(30) Foreign Application Priority Data
Jan. 18, 2013 (CN) 2013200393675

(51) Int. Cl. A61H 39/06

(52) U.S. Cl. CPC A61H 39/06
USPC 604/290; 607/96; 604/291; 607/112

(57) ABSTRACT

This invention is directed to a moxibustion therapy device and its use. The moxibustion therapy device comprises a housing, an integrated electric circuit board inside the housing, a power supply module, and a heating module. A protruding portion on one side of the housing is covered with a metal mesh cover. The integrated electric circuit board, the power supply module, and the heating module are connected to one another. The heating module is tightly pressed against one side of the metal mesh cover. Users can use the moxibustion therapy device at anytime anywhere without others' assistance. The moxibustion therapy device can help people expel cold and dampness and relieve pain.

### FIELD OF THE INVENTION

The present invention relates to a moxibustion therapy device and particularly relates to a moxibustion heat therapy device that is convenient to use.

### BACKGROUND OF THE INVENTION

Moxibustion is a traditional Chinese medical therapy. It has been utilized by Chinese people for thousands of years. However, there are some limitations to the traditional moxibustion. For example, patients usually can not provide moxibustion to themselves. They need assistance from someone else. At the same time, many other issues, such as environment, materials, and time, constrain the implementation of moxibustion. These issues have made moxibustion inconvenient to implement. A convenient moxibustion therapy device that is easy to use is needed.

### SUMMARY OF THE INVENTION

In order to overcome the above-mentioned technical defects, the present invention provides a moxibustion therapy device that is convenient to use and can be used anytime, anywhere, and by patients themselves without assistance.

The moxibustion therapy device comprises a housing comprising a protruding portion on a surface of the housing, wherein the protruding portion is covered with a metal mesh cover; an integrated electric circuit board inside the housing; a power supply module; and a heating module attached to the metal mesh cover, wherein the integrated electric circuit board, the power supply module, and the heating module are connected to one another.

In one embodiment, the moxibustion therapy device further comprises a rear cover attached to the housing.

In one embodiment, the moxibustion therapy device further comprises an indicator device and a control switch, wherein the indicator device and the control switch are connected to the integrated circuit board.

In one embodiment, the moxibustion therapy device further comprises a metal mesh cover confining ring fastening the metal mesh cover to the protruding portion.

The moxibustion therapy device may further comprise a washer between the protruding portion and the metal mesh cover, making the heating module pressed tightly against a first side of the metal mesh cover.

The moxibustion therapy device may also comprise a wrapping cladding layer and a cladding confining ring, wherein the wrapping cladding covers a second side of the metal mesh cover, and the cladding confining ring fastens the wrapping cladding layer to the metal mesh cover. The wrapping cladding layer is fabric made of any material that is suitable for contact with human skin, such as cotton, flax, or wool.

In one embodiment, the moxibustion therapy device further comprises an indicator device on one side of the housing, wherein the indicator device is connected to the integrated circuit board. The indicator device comprises at least one indicator light indicating different temperature levels by different colors. The indicator device may comprise three indicator lights, one green light indicating a low temperature, one orange light indicating a medium temperature, and one red light indicating a high temperature.

In one embodiment, the housing of the moxibustion therapy device further comprises a charging port for connecting an external power source to provide power to the power module.

In one embodiment, the housing of the moxibustion therapy device further comprises an attachment device attaching the moxibustion therapy device to a human body. The attachment device is selected from the group consisting of an elastic band, a tape, and a belt.

The current invention also includes a method of using the moxibustion therapy device, comprising applying mugwort cream; placing the moxibustion therapy device on a patient's body.

The method may further comprise taking away the moxibustion therapy device from the patient's body.

The steps placing the moxibustion therapy device on the patient's body and taking away the moxibustion therapy device from the patient's body can be repeated.

The method may further comprise adjusting the temperature of the moxibustion therapy device.

The method may further comprise attaching the moxibustion therapy device to the patient's body with the attachment device.

The current invention also includes a kit for moxibustion therapy, comprising the moxibustion therapy device of the present invention and mugwort cream.

Based on the above description, patients can use the moxibustion therapy device of the present invention independently anytime or anywhere, even when traveling. The device can help people expel cold and dampness and relieve pain.

### BRIEF DESCRIPTION OF THE DRAWING FIGURES

FIG. 1 is a forward explosion figure of the moxibustion therapy device.

FIG. 2 is a reverse explosion figure of the moxibustion therapy device.

FIG. 3 is a figure of the moxibustion therapy device.

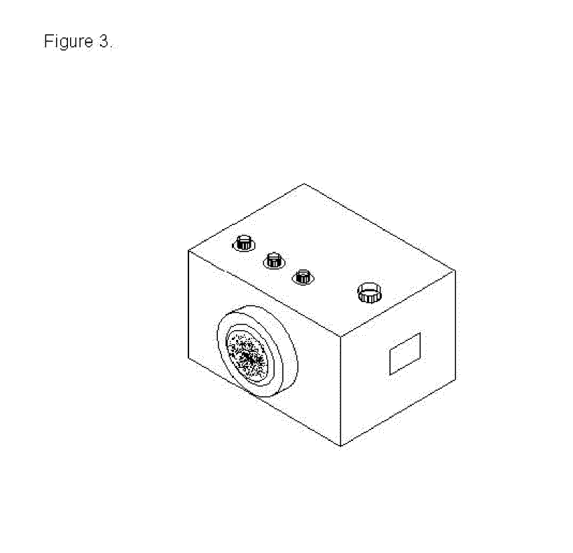

### DETAILED DESCRIPTION

The following detailed embodiments presented herein are for illustrative purposes. That is, these detailed embodiments are intended to be exemplary of the present invention for the purposes of providing and aiding a person skilled in the pertinent art to readily understand how to make and use of the present invention.

Accordingly, the detailed discussion herein of one or more embodiments is not intended, nor is to be construed, to limit the metes and bounds of the patent protection afforded the present invention, in which the scope of patent protection is intended to be defined by the claims and their equivalents thereof. Therefore, embodiments not specifically addressed herein, such as adaptations, variations, modifications, and equivalent arrangements, should be and are considered to be implicitly disclosed by the illustrative embodiments and claims described herein and therefore fall within the scope of the present invention.

Further, it should be understood that, although the claimed method may be shown and described as being in a sequence or temporal order, the steps of any such method are not limited to being carried out in any particular sequence or order, absent an indication otherwise. That is, the claimed method steps are to be considered to be capable of being carried out in any sequential combination or permutation order while still falling within the scope of the present invention.

Additionally, it is important to note that each term used herein refers to that which a person skilled in the relevant art would understand such term to mean based on the contextual use of such term herein. To the extent that the meaning of a term used herein, as understood by the person skilled in the relevant art based on the contextual use of such term, differs in any way from any particular dictionary definition of such term, it is intended that the meaning of the term as understood by the person skilled in the relevant art should prevail.

Furthermore, a person skilled in the art of reading claimed inventions should understand that “a” and “an” each generally denotes “at least one,” but does not exclude a plurality unless the contextual use dictates otherwise. And that the term “or” denotes “at least one of the items,” but does not exclude a plurality of items of the list.

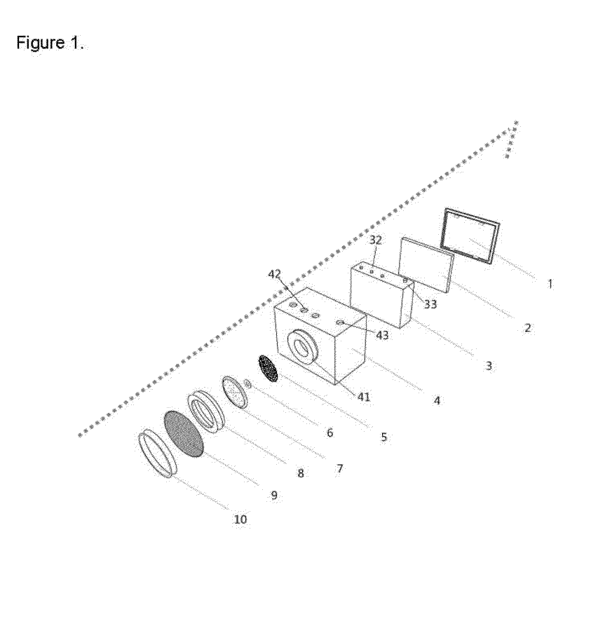

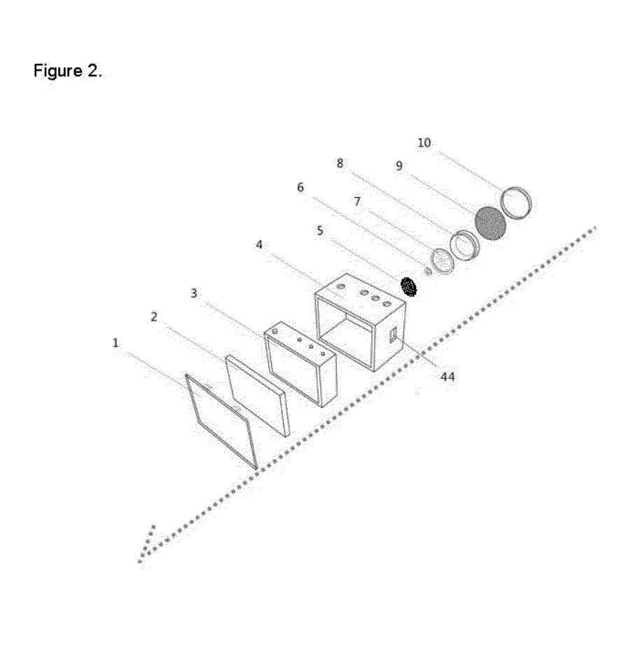

The preferred embodiment is shown in drawing FIG. 1 and 2 from forward and reverse directions respectively. The dotted arrows in the figures show the directions.

As shown in FIGS. 1 and 2, a moxibustion therapy device comprises a housing 4, a rear cover 1 attached to the housing, an integrated circuit board 3 inside the housing 4, a battery 2, and a heating tablet 6. The integrated circuit board 3 is connected with the battery 2. The heating tablet 6 is connected to the integrated circuit board 3 with a wire. The battery 2 can be a rechargeable battery.

On a surface of the housing 4 is a protruding portion 41. The protruding portion includes a hollow space through which the heating tablet 6 is connected to the integrated circuit board 3. A first end of the protruding portion is attached to the housing, and a second end of the protruding portion is not attached to the housing and is covered by a metal mesh cover 7. A mesh cover confining ring 8 fastens the metal mesh cover 7 to the protruding portion 41. There is a washer 5 between the metal mesh cover 7 and the protruding portion 41, which makes the heating tablet 6 pressed tightly against a first side of the metal mesh cover 7.

For the user to avoid direct contact of the metal mesh cover 7 with patients' skin and therefore, use the moxibustion therapy device more comfortably, an embodiment of the present invention provides a wrapping cladding layer 9 that covers a second side of the metal mesh cover 7. A cladding confining ring 10 is provided to fasten the wrapping cladding layer 9 to the metal mesh cover 7. The wrapped cladding layer can be fabric made of any material that is suitable for contact with human skin, such as cotton, flax, or wool.

In order for the user to be more intuitively aware of the work of the moxibustion therapy device and to facilitate its operation, an indicator device, 32 and a control switch 33 are provided on one side of the housing. The indicator device 32 and the control switch 33 are connected to the integrated circuit board 3. The indicator device 32 is controlled by the integrated circuit board 3.

The indicator device 32 indicates different status of the moxibustion therapy device, such as the temperature. The control switch 33 controls the status of the moxibustion therapy device, such as the temperature of the moxibustion therapy device's treating part, in one embodiment, the heating tablet 6.

In one embodiment, the indicator device 32 and the control switch 33 are fixed on the integrated circuit board 3. The indicator device 32 and the control switch 33 are exposed through the indicator device hole 42 and the control switch hole 43 on one side of the housing respectively.

In one embodiment of the present invention, the indicator device 32 comprises indicator lights of different colors. In one embodiment as shown in the figures, there are three indicator lights indicating different temperatures, for example, one green light indicating low temperature, one orange light indicating medium temperature, and one red light indicating high temperature.

When the power of the battery 2 in the moxibustion therapy device is low, the battery 2 can be replaced by opening the rear cover 1. If the battery is rechargeable, the battery can be recharged through a charging port 44 on one side the housing 4.

The moxibustion therapy device is small in size. Each of its three dimensions can be up to 4 inches. Because of its small size, it is convenient to carry the moxibustion therapy device around such as in the patient's pocket or bag. It is also easy to attach the moxibustion therapy device to a patient's body for moxibustion therapy.

For the moxibustion therapy device to be attached to the human body, the housing 4 may include an attachment device (not shown), such as an elastic band, a tape, or a belt.

The moxibustion therapy device uses electricity to cause the heating tablet 6 to emit heat. Patients can choose the appropriate temperature level to work on their desired body parts to expel cold and dampness and relieve pain. The temperature can be adjusted according to each individual's comfort level.

A rechargeable moxibustion therapy device can include a charger. Before using the moxibustion therapy device, it needs to be charged. The charger is plugged into an electricity outlet, and the moxibustion therapy device is attached to the charger. The charger can include an indicator unit, such as a light, which will flash red 10 times or more once the charger is plugged into the outlet. The indicator unit will then stop flashing and stay red when the moxibustion therapy device is being charged. When the moxibustion therapy device is fully charged and ready to use, the indicator unit will turn green.

Before the moxibustion therapy device is applied to a patient's body, a very thin layer of mugwort cream is applied to the skin at the patient's body part to be treated.

There are different ways of using the moxibustion therapy device, and two ways are described herein—intermittent heating and constant heating. The patent places the moxibustion therapy device on the desired body part with the moxibustion therapy device's front side—the side with the cladding layer—in contact with the skin. The patient then turns on the moxibustion therapy device and chooses the desired heating temperature. The patient can hold the moxibustion therapy device by hand or using the attachment device. When the moxibustion therapy device is used for intermittent heating, the patient places the moxibustion therapy device on the body for a period of time, such as 20-30 minutes, and then take it away from the body. The moxibustion therapy device is placed on and off the patient's body several times during the treatment. When the moxibustion therapy device is used for constant heating, the patient leaves the moxibustion therapy device on the body for the desired treatment time.

The moxibustion therapy device is convenient, safe, and affordable to use. Further, by the use of an attachment device, the present invention can be fixed to any part of the human body, making the operation more convenient.

While a number of embodiments of the present invention have been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Throughout this specification, unless the context requires otherwise, the word “comprise” or variations such as “comprises” or “comprising” or the term “includes” or variations, thereof, or the term “having” or variations, thereof will be understood to imply the inclusion of a stated element or integer or group of elements or integers but not the exclusion of any other element or integer or group of elements or integers. In this regard, in construing the claim scope, an embodiment where one or more features is added to any of the claims is to be regarded as within the scope of the invention given that the essential features of the invention as claimed are included in such an embodiment.

Those skilled in the art will appreciate that the invention described herein is susceptible to variations and modifications other than those specifically described. It is to be understood that the invention includes all such variations and modifications that fall within its spirit and scope. The invention also includes all of the steps, features, compositions and compounds referred to or indicated in this specification, individually or collectively, and any and all combinations of any two or more of said steps or features.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A moxibustion therapy device comprising:
a housing comprising a protruding portion on a surface of the housing, wherein the protruding portion is covered with a metal mesh cover;
an integrated electric circuit board inside the housing;
a power supply module; and
a heating module attached to the metal mesh cover,
wherein the integrated electric circuit board, the power supply module, and the heating module are connected to one another.

2. The moxibustion therapy device of claim 1, further comprising a rear cover attached to the housing.

3. The moxibustion therapy device of claim 1, further comprising an indicator device and a control switch, wherein the indicator device and the control switch are connected to the integrated circuit board.

4. The moxibustion therapy device of claim 1, further comprising a metal mesh cover confining ring fastening the metal mesh cover to the protruding portion.

5. The moxibustion therapy device of claim 4, further comprising a washer between the protruding portion and the metal mesh cover, making the heating module pressed tightly against a first side of the metal mesh cover.

6. The moxibustion therapy device of claim 4, further comprising a wrapping cladding layer and a cladding confining ring, wherein the wrapping cladding covers a second side of the metal mesh cover, and the cladding confining ring fastens the wrapping cladding layer to the metal mesh cover.

7. The moxibustion therapy device of claim 6, wherein the wrapping cladding layer is fabric made of any material that is suitable for contact with human skin.

8. The moxibustion therapy device of claim 7, wherein the wrapping cladding layer is fabric made of a materials selected from the group consisting of cotton, flax, and wool.

9. The moxibustion therapy device of claim 1, further comprising an indicator device on one side of the housing, wherein the indicator device is connected to the integrated circuit board.

10. The moxibustion therapy device of claim 9, wherein the indicator device comprises at least one indicator light indicating different temperature levels by different colors.

11. The moxibustion therapy device of claim 10, wherein the indicator device comprises three indicator lights, one green light indicating a low temperature, one orange light indicating a medium temperature, and one red light indicating a high temperature.

12. The moxibustion therapy device of claim 1, wherein the housing further comprises a charging port for connecting an external power source to provide power to the power module.

13. The moxibustion therapy device of claim 1, wherein the housing further comprises an attachment device attaching the moxibustion therapy device to a human body.

14. The moxibustion therapy device of claim 13, wherein the attachment device is selected from the group consisting of an elastic band, a tape, and a belt.

15. A method of using the moxibustion therapy device of claim 1, comprising:
applying mugwort cream;
placing the moxibustion therapy device on a patient's body.

16. The method of claim 15, further comprising:
taking away the moxibustion therapy device from the patient's body.

17. The method of claim 16, wherein the steps placing the moxibustion therapy device on the patient's body and taking away the moxibustion therapy device from the patient's body are repeated.

18. The method of claim 15, further comprising adjusting the temperature of the moxibustion therapy device.

19. The method of claim 15, further comprising attaching the moxibustion therapy device to the patient's body with the attachment device.

20. A kit, comprising:
the moxibustion therapy device of claim 1; and
mugwort cream.
